(19) United States
(12) Patent Application Publication
(10) Pub. No.: US 2026/0126557 A1
(43) Pub. Date: May 7, 2026

(54) SEISMIC-STRATIGRAPHIC VALIDATION FOR SUBSURFACE MODELING

(71) Applicant: Chevron U.S.A. Inc., San Ramon, CA (US)

(72) Inventors: Ryan David Wilson, Spring, TX (US); Paul Daniel Vincent, Houston, TX (US); Tao Sun, Missouri City, TX (US); Edith Jacoba Miller, Midland, TX (US)

(21) Appl. No.: 18/939,240

(22) Filed: Nov. 6, 2024

(51) Int. Cl. G01V 1/30

(52) U.S. Cl. CPC G01V 1/30; G01V 2210/66

(57) ABSTRACT

A subsurface representation of a subsurface region is generated section by section from the base section to the top section. Seismic characteristics in a section of the subsurface representation are simulated, and the simulated seismic characteristics are compared with seismic characteristics in a corresponding section of the subsurface region to validate the section of the subsurface representation. Once a section of the subsurface representation is validated, the next/overlying section of the subsurface representation is generated. The underlying section provides one or more boundary conditions to constrain generation of the overlying section.

### FIELD

The present disclosure relates generally to the field of subsurface modeling using seismic-stratigraphic validation.

### BACKGROUND

Computer models of a subsurface region may be generated for use in exploration, development, and/or production from the subsurface region. Calibrating the computer models using seismic data may enable more accurate modeling of the surface region.

### SUMMARY

This disclosure relates to subsurface modeling using seismic-stratigraphic validation. Seismic information and/or other information for a subsurface region may be obtained. The seismic information may characterize seismic characteristics in the subsurface region. A section of a subsurface representation for the subsurface region may be generated. The subsurface representation may define simulated subsurface configuration for the subsurface region. Simulated seismic characteristics in the section of the subsurface representation may be determined based on the simulated subsurface configuration in the section of the subsurface representation and/or other information. The section of the subsurface representation may be validated based on the simulated seismic characteristics in the section of the subsurface representation matching the seismic characteristics in a corresponding section of the subsurface region and/or other information. The subsurface representation may be generated section by section, from a base section to a top section. An overlying section may be generated after validation of an underlying section. The underlying section may provide one or more boundary conditions to constrain generation of the overlying section.

A system for subsurface modeling using seismic-stratigraphic validation may include one or more electronic storage, one or more processors and/or other components. The electronic storage may store information relating to a subsurface region, seismic information, information relating to seismic characteristics, information relating to a subsurface representation, information relating to sections of the subsurface representation, information relating to simulated subsurface configuration, information relating to simulated seismic characteristics, information relating to validation of the sections of the subsurface representation, and/or other information.

The processor(s) may be configured by machine-readable instructions. Executing the machine-readable instructions may cause the processor(s) to facilitate subsurface modeling using seismic-stratigraphic validation. The machine-readable instructions may include one or more computer program components. The computer program components may include one or more of a seismic characteristic component, a section component, a simulated seismic characteristic component, a validation component, and/or other computer program components.

The seismic characteristic component may be configured to obtain seismic information and/or other information for a subsurface region. The seismic information for the subsurface region may characterize seismic characteristics in the subsurface region. In some implementations, the seismic information for the subsurface region may include field measurement from the subsurface region. In some implementations, the seismic characteristics may include seismic traces.

The section component may be configured to generate multiple sections of a subsurface representation for the subsurface region. The subsurface representation may define simulated subsurface configuration for the subsurface region. In some implementations, a given section of the subsurface representation may correspond to a layer of the subsurface region.

In some implementations, the simulated subsurface configuration in the sections of the subsurface representation may include elastic properties. A section of the subsurface representation may be populated with the elastic properties based on materials in the corresponding section of the subsurface region and/or other information.

In some implementations, multiple versions of a section of the subsurface representation may be generated. A single version of the section may be selected for inclusion in the subsurface representation.

The subsurface representation may be generated section by section, from a base section to a top section. An overlying section may be generated after validation of an underlying section. The underlying section may provide one or more boundary conditions to constrain generation of the overlying section. In some implementations, the boundary condition(s) provided by the underlying section to constrain the generation of the overlying section may include lower geometry of the overlying section. The boundary condition(s) provided by the underlying section to constrain the generation of the overlying section may further includes initial conditions for sediment transport.

The simulated seismic characteristic component may be configured to determine simulated seismic characteristics in the section(s) of the subsurface representation. The simulated seismic characteristics in a section of the subsurface representation may be determined based on the simulated subsurface configuration in the section of the subsurface representation and/or other information. In some implementations, the simulated seismic characteristics may include simulated seismic traces.

The validation component may be configured to validate the section(s) of the subsurface representation. A section of the subsurface representation may be validated based on the simulated seismic characteristics in the section of the subsurface representation matching the seismic characteristics in a corresponding section of the subsurface region and/or other information.

In some implementations, exploration, development, and/or production from the subsurface region may be performed based on the subsurface representation for the subsurface region and/or other information.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a,” “an,” and “the” include plural referents unless the context clearly dictates otherwise.

### BRIEF DESCRIPTION OF THE DRAWINGS

FIG. 1 illustrates an example system for subsurface modeling using seismic-stratigraphic validation.

FIG. 2 illustrates an example method for subsurface modeling using seismic-stratigraphic validation.

FIG. 3 illustrates an example flow diagram for subsurface modeling using seismic-stratigraphic validation.

FIG. 4A illustrates an example base section of a subsurface representation.

FIG. 4B illustrates an example validation of a base section of a subsurface representation.

FIG. 4C illustrates an example middle section of a subsurface representation generated on top of a base section of the subsurface representation.

FIG. 4D illustrates an example validation of a middle section of a subsurface representation.

FIG. 4E illustrates an example middle section of a subsurface representation generated on top of a base section of the subsurface representation.

FIG. 4F illustrates an example validation of a middle section of a subsurface representation.

FIG. 4G illustrates an example subsurface representation with a base section, a middle section, and a top section.

### DETAILED DESCRIPTION

The present disclosure relates to subsurface modeling using seismic-stratigraphic validation. A subsurface representation of a subsurface region is generated section by section from the base section to the top section. Seismic characteristics in a section of the subsurface representation are simulated, and the simulated seismic characteristics are compared with seismic characteristics in a corresponding section of the subsurface region to validate the section of the subsurface representation. Once a section of the subsurface representation is validated, the next/overlying section of the subsurface representation is generated. The underlying section provides one or more boundary conditions to constrain generation of the overlying section.

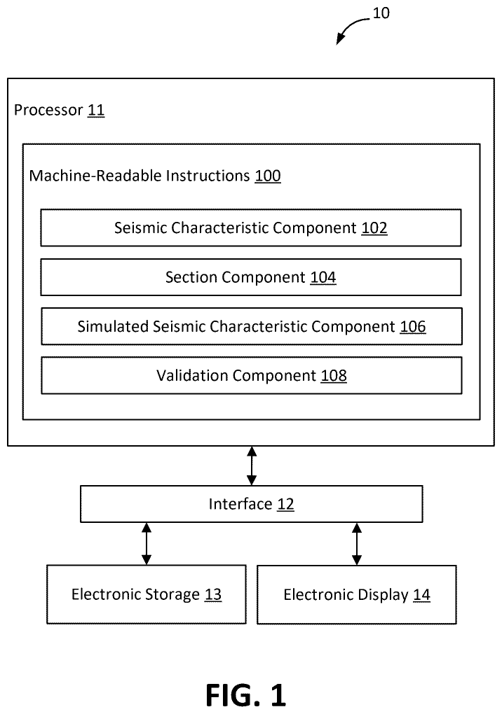

The methods and systems of the present disclosure may be implemented by a system and/or in a system, such as a system 10 shown in FIG. 1. The system 10 may include one or more of a processor 11, an interface 12 (e.g., bus, wireless interface), an electronic storage 13, an electronic display 14, and/or other components. Seismic information and/or other information for a subsurface region may be obtained by the processor 11. The seismic information may characterize seismic characteristics in the subsurface region. A section of a subsurface representation for the subsurface region may be generated by the processor 11. The subsurface representation may define simulated subsurface configuration for the subsurface region. Simulated seismic characteristics in the section of the subsurface representation may be determined by the processor 11 based on the simulated subsurface configuration in the section of the subsurface representation and/or other information. The section of the subsurface representation may be validated by the processor 11 based on the simulated seismic characteristics in the section of the subsurface representation matching the seismic characteristics in a corresponding section of the subsurface region and/or other information. The subsurface representation may be generated section by section, from a base section to a top section. An overlying section may be generated after validation of an underlying section. The underlying section may provide one or more boundary conditions to constrain generation of the overlying section.

The electronic storage 13 may be configured to include one or more electronic storage media that electronically stores information. The electronic storage 13 may store software algorithms, information determined by the processor 11, information received remotely, and/or other information that enables the system 10 to function properly. For example, the electronic storage 13 may store information relating to a subsurface region, seismic information, information relating to seismic characteristics, information relating to a subsurface representation, information relating to sections of the subsurface representation, information relating to simulated subsurface configuration, information relating to simulated seismic characteristics, information relating to validation of the sections of the subsurface representation, and/or other information.

The electronic display 14 may refer to an electronic device that provides visual presentation of information. The electronic display 14 may include a color display and/or a non-color display. The electronic display 14 may be configured to visually present information. The electronic display 14 may present information using/within one or more graphical user interfaces. For example, the electronic display 14 may present information relating to a subsurface region, seismic information, information relating to seismic characteristics, information relating to a subsurface representation, information relating to sections of the subsurface representation, information relating to simulated subsurface configuration, information relating to simulated seismic characteristics, information relating to validation of the sections of the subsurface representation, and/or other information.

Computer models of a subsurface region (subsurface representations) may be generated for use in exploration, development, and/or production from the subsurface region. Subsurface representations may be generated to capture variations of subsurface configurations within different parts of the subsurface region. A subsurface representations may be calibrated to ensure that simulated subsurface configuration within the subsurface representation accurately reflects actual subsurface configuration within a subsurface region. Presently, there remains a gap in calibrating subsurface representations using seismic data. Calibrating subsurface representation using seismic data may enable more accurate modeling of surface regions.

Physics-based forward modeling technique may be used to simulate geologically expected variance in subsurface properties, including shifts in subsurface properties over space and time. Physics-based forward modeling technique may be used to generate entire subsurface representations, with different subsurface representations reflecting different possible subsurface configuration within the subsurface region. Numerous subsurface representations may be generated for numerous possible subsurface configuration within the subsurface region. However, direct comparison of numerous subsurface representations with seismic data for all possible realization is not practical in terms of time and costs.

The present disclosure provides a tool to calibrate subsurface representations using seismic data. A subsurface representation is generated section-by-section, from the base section to the top section. Individual sections of the subsurface representations are validated using seismic data as they are included in the subsurface representation. The seismic data is used to constrain the generation of the sections of the subsurface region. An underlying section of the subsurface representation, which has been validated using seismic data, is used to constrain an overlaying section of the subsurface representation. Validation of the sections as the subsurface representation is being built enables efficient and accurate modeling of the subsurface region.

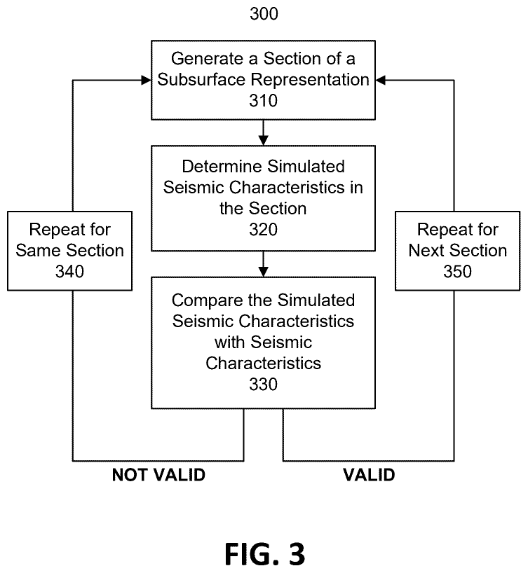

FIG. 3 illustrates an example flow diagram 300 for subsurface modeling using seismic-stratigraphic validation. At step 310, a section of a subsurface representation may be generated. A section of the subsurface representation may correspond to a layer or other part of the subsurface region. Generation of a section of a subsurface representation may include creation of a new section for potential inclusion in the subsurface representation or selection of an existing section of an existing/different subsurface representation for potential inclusion in the subsurface representation. For example, a section may be created using physics-based forward modeling for inclusion in the subsurface representation. As another example, one or more subsurface representations may have been previously generated, and a section of a previously generated subsurface representation may be selected for inclusion in the subsurface representation. The section of the subsurface representation may define simulated subsurface configuration (e.g., elastic properties) for the corresponding section (e.g., layer) of the subsurface region. For example, the section of the subsurface representation may be populated with simulated elastic properties based on materials in the corresponding section of the subsurface region. For instance, the section of the subsurface representation may be populated with simulated elastic properties based on known elastic properties for materials in the corresponding section of the subsurface region.

At step 320, simulated seismic characteristics in the section of the subsurface representation may be determined. The simulated seismic characteristics in the section of the subsurface representation may be determined based on the simulated subsurface configuration in the section of the subsurface representation. For example, simulated seismic traces in the section of the subsurface representation may be determined based on the elastic properties in the section of the subsurface representation. Simulated seismic traces in the section may be forward modeled to represent the expected response of the elastic wavefield to velocity and density contrast across interfaces of rocks/sediments as energy travels through the section.

At step 330, the simulated seismic characteristics in the section of the subsurface representation may be compared with seismic characteristics in the corresponding section of the subsurface region. For example, simulated seismic traces in the section of the subsurface representation may be compared with seismic traces in the corresponding section of the subsurface region. The seismic traces in the corresponding section of the subsurface region may be obtained from field measurements. The simulated seismic traces and the actual/measured seismic traces may be compared line-by-line or multiple lines at a time.

The comparison may be performed to determine whether the section of the subsurface representation is valid or not. For example, based on the difference between the simulated seismic characteristics in the section of the subsurface representation and the actual/measured seismic characteristics in the corresponding section of the subsurface region being less than a threshold amount, the section of the subsurface representation may be validated. Based on the difference between the simulated seismic characteristics in the section of the subsurface representation and the actual/measured seismic characteristics in the corresponding section of the subsurface region being greater than a threshold amount, the section of the subsurface representation may not be validated.

If the section of the subsurface representation is not valid, the process may be repeated for the same section 340. Another version of the section of the subsurface representation may be generated to represent the corresponding section of the subsurface region. For example, a new section of the subsurface representation may be created (e.g., using a physics-based forward modeling technique) or a different section of a previously generated subsurface representation may be selected for potential inclusion in the subsurface representation. The process may be repeated until a section with simulated seismic characteristics that are sufficiently similar to actual seismic characteristics is found.

If the section of the subsurface representation is valid, the process may be repeated for the next section 350. The validated section may be locked in the subsurface representation and the next section of the subsurface representation may be generated. The next section in the subsurface representation may include the section above the locked-in section. The locked-in section of the subsurface representation may provide boundary condition(s) (e.g., geometry, initial conditions for sediment transport) to constrain the generation of the next section. The process may be repeated until the entire subsurface representation is completed for the subsurface region, from the base section to the top section. The completed subsurface representation may include realistic subsurface properties/configuration (e.g., realistic lithology, porosity, permeability) and match the seismic data for the subsurface region. The completed subsurface representation may be used to perform exploration, development, and/or production from the subsurface region.

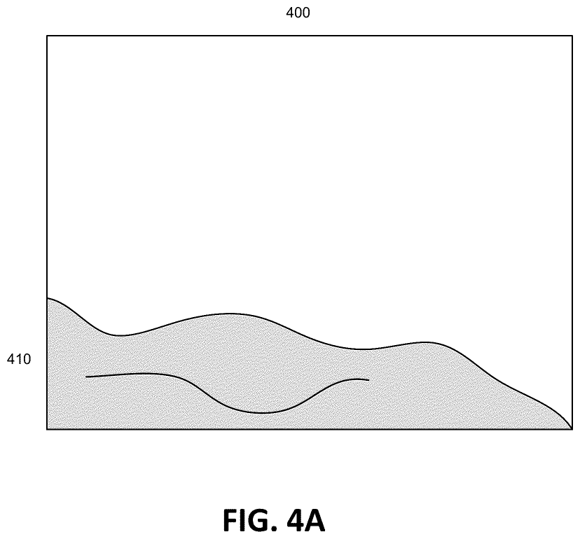

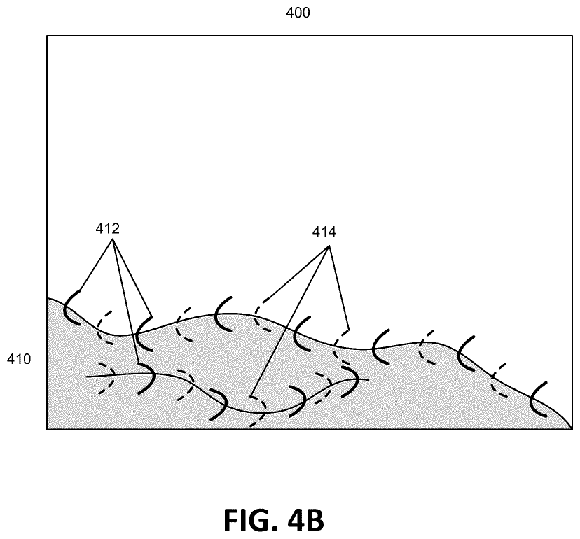

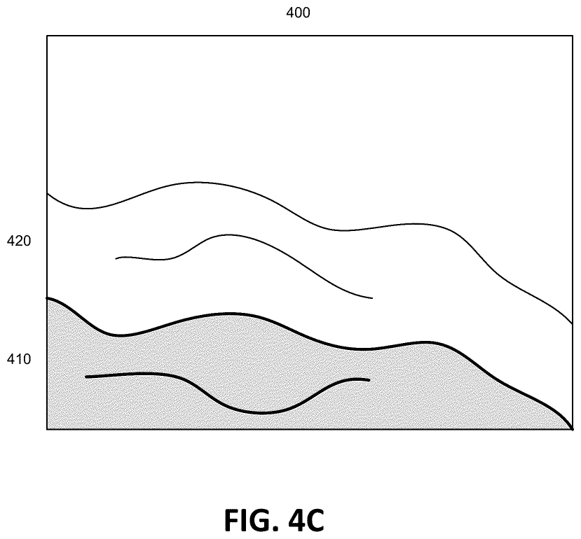

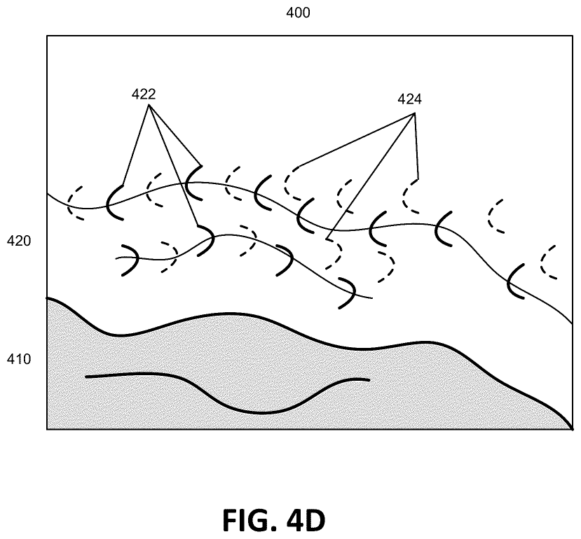

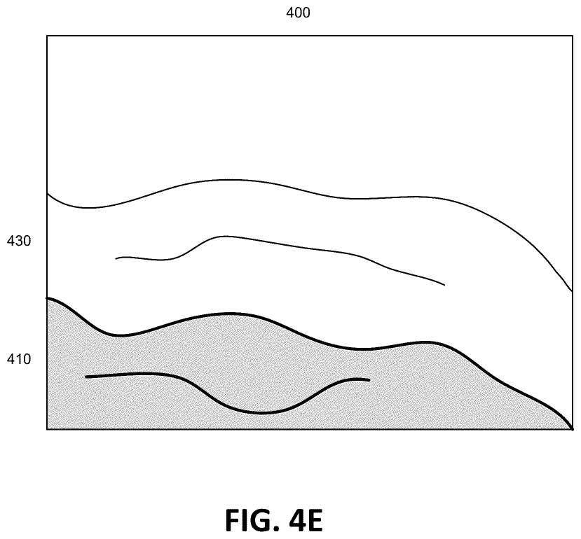

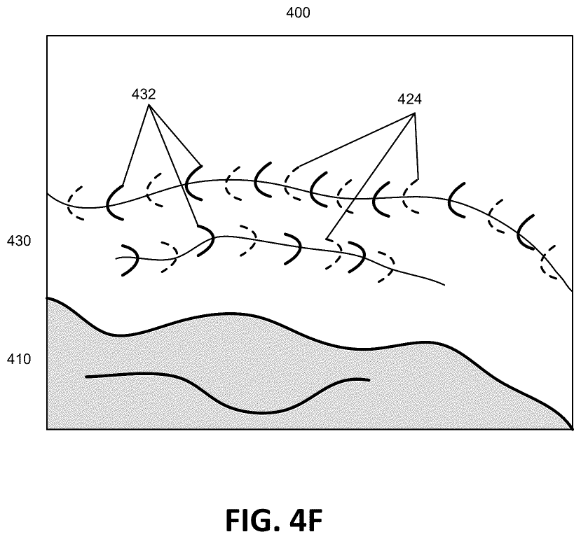

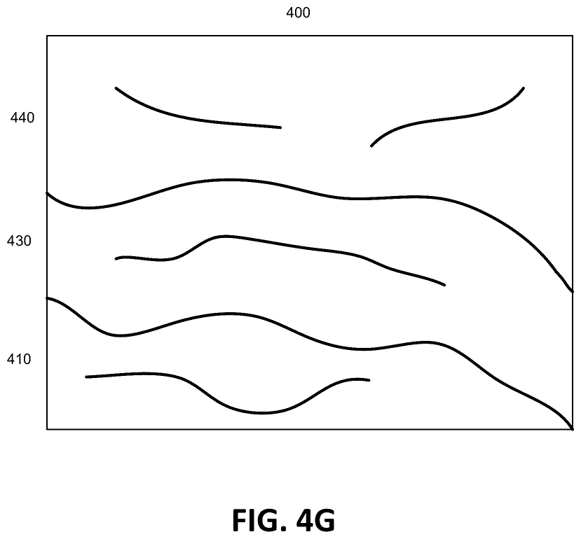

FIG. 4A illustrates an example base section 410 of a subsurface representation 400. The subsurface representation 400 may be generated to serve as a model for a subsurface region. The base section 410 may include a new section created to serve as the base section 410 or a section of an existing subsurface representation that has been picked to serve as the base section 410.

FIG. 4B illustrates an example validation of the base section 410 of the subsurface representation 400. The base section 410 may be populated with elastic properties, and the elastic properties in the base section 410 may be used to forward model simulated seismic traces 412 in the base section 410. The simulated seismic traces 412 may be compared with actual/measured seismic traces 414 in the corresponding section of the subsurface region. Based on the simulated seismic traces 412 matching the actual/measured seismic traces 414 (e.g., location, direction, and/or amount deviating by less than a threshold amount), the base section 410 may be validated and locked in the subsurface representation 400. The base section 410 may be used to constrain the generation of the next/overlying section of the subsurface representation 400.

FIG. 4C illustrates an example middle section 420 of the subsurface representation 400 generated on top of the base section 410 of the subsurface representation 400. Generation of the middle section 420 may be constrained by the base section 410. The middle section 420 may include a new section created to serve as the middle section 420 or a section of an existing subsurface representation that has been picked to serve as the middle section 420.

FIG. 4D illustrates an example validation of the middle section 420 of the subsurface representation 400. The middle section 420 may be populated with elastic properties, and the elastic properties in the base section 420 may be used to forward model simulated seismic traces 422 in the base section 420. The simulated seismic traces 422 may be compared with actual/measured seismic traces 424 in the corresponding section of the subsurface region. Based on the simulated seismic traces 422 not matching the actual/measured seismic traces 424 (e.g., location, direction, and/or amount deviating by more than a threshold amount), the middle section 420 may not be validated and another section may be generated for the middle section 420.

FIG. 4E illustrates an example middle section 430 of the subsurface representation 400 generated on top of the base section 410 of the subsurface representation 400. Generation of the middle section 430 may be constrained by the base section 410. The middle section 430 may include a new section created to serve as the middle section 430 or a section of an existing subsurface representation that has been picked to serve as the middle section 430.

FIG. 4F illustrates an example validation of the middle section 430 of the subsurface representation 400. The middle section 430 may be populated with elastic properties, and the elastic properties in the middle section 430 may be used to forward model simulated seismic traces 432 in the base section 410. The simulated seismic traces 432 may be compared with actual/measured seismic traces 424 in the corresponding section of the subsurface region. Based on the simulated seismic traces 432 matching the actual/measured seismic traces 424 (e.g., location, direction, and/or amount deviating by less than a threshold amount), the middle section 430 may be validated and locked in the subsurface representation 400. The middle section 430 may be used to constrain the generation of the next/overlying section of the subsurface representation 400.

FIG. 4G illustrates the example subsurface representation 400 with the base section 410, the middle section 430, and a top section 440. The generation of the top section 440 may be constrained by the middle section 430. The subsurface representation 400 may be used as a sediment model for the subsurface region. The subsurface representation 400 may be physically realistic from a depositional standpoint and may be consistent with field measurements from the subsurface region. The piecewise generation of the subsurface representation 400 with concurrent (e.g., section-by-section) validation using seismic data enables fast, efficient, and accurate generation of the subsurface representation 400. The piecewise generation of the subsurface representation 400 results in the entirety of the subsurface representation 400 matching the seismic data from the subsurface region.

While FIG. 4G shows the subsurface representation 400 with three sections, this is merely an example and is not meant to be limiting. Other section numbers of subsurface representations are contemplated. While FIG. 4G shows the subsurface representation 400 in two dimensions, this is merely an example and is not meant to be limiting. Other dimensions of subsurface representations are contemplated.

Referring back to FIG. 1, the processor 11 may be configured to provide information processing capabilities in the system 10. As such, the processor 11 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 11 may be configured to execute one or more machine-readable instructions 100 to facilitate subsurface modeling using seismic-stratigraphic validation. The machine-readable instructions 100 may include one or more computer program components. The machine-readable instructions 100 may include one or more of a seismic characteristic component 102, a section component 104, a simulated seismic characteristic component 106, a validation component 108, and/or other computer program components.

The seismic characteristic component 102 may be configured to obtain seismic information and/or other information for a subsurface region. Obtaining seismic information may include one or more of accessing, acquiring, analyzing, determining, developing, examining, generating, identifying, loading, locating, measuring, opening, preparing, receiving, retrieving, reviewing, selecting, storing, and/or otherwise obtaining the seismic information. The seismic characteristic component 102 may obtain seismic information from one or more locations. For example, the seismic characteristic component 102 may obtain seismic information from a storage location, such as the electronic storage 13, electronic storage of a device accessible via a network, and/or other locations. The seismic characteristic component 102 may obtain seismic information from one or more hardware components (e.g., a computing device, a sensor) and/or one or more software components (e.g., software running on a computing device). The seismic characteristic component 102 may obtain seismic information from one or more users. Seismic information may be stored within a single file or multiple files.

In some implementations, the seismic information for a subsurface region may include field measurement from the subsurface region. For example, the seismic information for the subsurface region may include seismic data measured from the subsurface region. Seismic data may include information generated by transmitting energy/acoustic waves into the earth using seismic transmitter(s) (e.g., acoustic wave generator and transmitter) and recording reflections (e.g., wave reflections) using seismic receiver(s) (e.g., acoustic wave receiver). Seismic data may indicate the type, size, shape, and/or depth of subsurface features/elements (e.g., a subsurface rock formation). Seismic data may include seismic traces within the subsurface region.

A subsurface region may refer to a part of earth located beneath the surface/located underground. A subsurface region may refer to a part of earth that is not exposed at the surface. A subsurface region may be defined in a single dimension (e.g., a point, a line) or in multiple dimensions (e.g., a surface, a volume). A subsurface region may include resources (e.g., hydrocarbon, oil, gas, water, other types of fluid).

The seismic information for the subsurface region may characterize seismic characteristics in the subsurface region. The seismic information for the subsurface region may characterize types and/or values of seismic characteristics in the subsurface region. A seismic characteristic may refer to attribute, property, quality, and/or other characteristic relating to vibration of earth/seismic waves in a subsurface region. A subsurface characteristic may refer to physical arrangement of materials and/or characteristic (e.g., attribute, property, quality, trait) of materials in a subsurface region that relates to/interacts with vibration of earth/seismic waves in the subsurface region. For example, a seismic characteristic in a subsurface region may include seismic traces in the subsurface region. A seismic trace may include seismic data recorded for one channel. A seismic trace may represent the response of the elastic wavefield to velocity and density contrast across interfaces of rock/sediments (e.g., layers of rocks/sediments) as energy travels through the surface region. Other types of subsurface characteristic are contemplated.

The seismic information may characterize seismic characteristics in the subsurface region as a function of location (e.g., latitude, longitude, depth) within the subsurface region. The seismic information may characterize seismic characteristics in different location within the subsurface region. The seismic information may characterize seismic characteristics over ranges of locations (e.g., area, volume).

The seismic information may characterize seismic characteristics in a subsurface region by including information that defines, delineates, describes, identifies, is associated with, quantifies, reflects, sets forth, and/or otherwise characterizes the seismic characteristics in the subsurface region. The seismic information may directly and/or indirectly characterize seismic characteristics in a subsurface region. For example, the seismic information may characterize seismic characteristics in a subsurface region by including information that specifies the values of the seismic characteristics and/or information from which the values of the seismic characteristics may be determined. The seismic information may characterize seismic characteristics in a subsurface region by including information that specifies the types of the seismic characteristics and/or information from which the types of the seismic characteristics may be determined. Other types of seismic information are contemplated.

The section component 104 may be configured to generate multiple sections of a subsurface representation for the subsurface region. A section of a subsurface representation and/or a subsurface representation may be generated using one or more physics-based forward modeling techniques. A section of a subsurface representation may correspond to a part of the subsurface region, such as a layer of the subsurface region.

A subsurface representation may refer to a computer-generated representation of a subsurface region, such as a one-dimensional, two-dimensional, and/or three-dimensional model of a subsurface region. A subsurface representation may define (include) subsurface configuration simulated by one or more subsurface models.

A subsurface model may refer to a computer model (e.g., program, tool, script, function, process, algorithm) that generates subsurface representations. A subsurface model may simulate subsurface configuration within a region underneath the surface (subsurface region). A subsurface model may simulate subsurface configurations by generating one or more subsurface representations. An example of a subsurface model is a computational stratigraphy model. A computational stratigraphy model may refer to a computer model that simulates depositional and/or stratigraphic processes on a grain size scale while honoring physics-based flow dynamics. A computational stratigraphy model may simulate rock properties, such as velocity and density, based on rock-physics equations and assumptions. Input to a computational stratigraphy model may include information relating to a subsurface region to be simulated. For example, input to a computational stratigraphy model may include paleo basin floor topography, paleo flow and sediment inputs to the basin, and/or other information relating to the basin. In some implementations, input to a computational stratigraphy model may include one or more paleo geologic controls, such as climate changes, sea level changes, tectonics and other allocyclic controls. Output of a computational stratigraphy model may include one or more subsurface representations. A subsurface representation generated by a computational stratigraphy model may be referred to as a computational stratigraphy model representation.

A computational stratigraphy model may include a forward stratigraphic model. A forward stratigraphic model may be an event-based model, a process mimicking model, a reduced physics based model, and/or a fully physics based model (e.g., fully based on physics of flow and sediment transport). A forward stratigraphic model may simulate one or more sedimentary processes that recreate the way stratigraphic successions develop and/or are preserved. The forward stratigraphic model may be used to numerically reproduce the physical processes that eroded, transported, deposited and/or modified the sediments over variable time periods. In a forward modelling approach, data may not be used as the anchor points for facies interpolation or extrapolation. Rather, data may be used to assess and validate the results of the simulation. Stratigraphic forward modelling may be an iterative approach, where input parameters have to be modified until the results are validated by actual data. Usage of other subsurface models and other subsurface representations are contemplated.

A subsurface representation may be used as and/or may be referred to as a digital analog. A subsurface representation may include geologically plausible arrangement of rock obtained from a modeling process (e.g., stratigraphic forward modeling process). A subsurface representation may be representative of a subsurface region in the real world. A subsurface region may include and/or be part of a reservoir or a field.

A reservoir may refer to a location at which one or more resources are stored. For example, a reservoir may refer to a location at which hydrocarbons are stored. For instance, a reservoir may refer to a location including rocks in which oil and/or natural gas have accumulated. A reservoir may include regions above the surface, at the surface, and/or below the surface. A reservoir may include one or more wells. For example, a reservoir may include one or more injection wells (e.g., for injection of fluid), one or more production wells (e.g., for extraction of oil or gas), and/or other wells. A reservoir may refer to a location in which buoyant forces keep hydrocarbons in place below a sealing caprock. A reservoir may refer to a location in which oil or natural gas do not readily flow into a well. A reservoir may refer to a location in which hydraulic fractures may be used to extract the stored resources, such as an unconventional reservoir (e.g., tight-sand, gas and/or oil shales). An unconventional reservoir may refer to a reservoir where hydrocarbons and/or other resources (e.g., oil, gas) are tightly bound to the rock fabric by strong capillary forces. Resources may be held by dense structure with lower permeability.

A field may refer to an accumulation, pool, or group of pools of hydrocarbons or other mineral resources in a subsurface region. A hydrocarbon field may consist of a reservoir in a shape that traps hydrocarbons and that is covered by an impermeable, sealing rock. A well may refer to a hole that is drilled in the ground. A well may be drilled in the ground for exploration and/or recovery of resources in the ground, such as water or hydrocarbons. For example, a well may be drilled for production of hydrocarbons (e.g., as a production well). The term “wellbore,” “well bore,” “borehole,” and the like may be utilized interchangeably with the term “well.”

A subsurface representation may define simulated subsurface configuration for the subsurface region. A subsurface representation may define simulated subsurface configuration at different locations within the subsurface region. A subsurface representation may define (e.g., characterize, describe, identify, quantify, etc.) simulated subsurface configuration of the subsurface region using values of one or more subsurface properties. The simulated subsurface configuration in different portions of the subsurface representation may be defined by/include subsurface propert(ies) simulated in those portions. A subsurface property may refer to property (e.g., characteristic, trait) of materials in a subsurface region. Examples of subsurface properties include density, flow velocity, grain size, grain type, grain lithology, material type, porosity, permeability, sediment concentration, water depth, and/or other properties of materials in a subsurface region. Subsurface properties may include one or more geological, petrophysical, geophysical, and/or stratigraphic properties.

For example, the subsurface representation may be made up of cells (e.g., voxels), and the cells may include and/or be associated with particular values of subsurface propert(ies). The cells of the subsurface representation may be used to convey information relating to the subsurface propert(ies) in the corresponding portions of the subsurface representation. For example, the cells of the subsurface representation may include and/or be associated with information on grain size, porosity, permeability, material, material contact (e.g., water-oil contact, gas-oil contact), and/or other subsurface properties to define the simulated subsurface configuration in the corresponding portions of the subsurface representation.

Simulated subsurface configuration may refer to attribute, quality, and/or characteristics of a subsurface region that is simulated within a subsurface representation. For example, simulated subsurface configuration in different sections of a subsurface representation may include elastic properties within the different sections. Elastic properties may define physical deformation that materials experience in response to an applied mechanical force. Examples of elastic properties include bulk modulus, shear modulus, Young's modulus, Poisson's ratio, wave velocity, and/or other elastic properties of materials. The elastic properties may include subsurface properties, such as density. The elastic properties simulated within the sections of the subsurface representation may be used to simulate seismic characteristics (e.g., seismic data, seismic traces) in the sections of the subsurface representation. In

In some implementations, a section of the subsurface representation may be populated with elastic properties based on materials in the corresponding section of the subsurface region and/or other information. For example, a section of the subsurface representation may be populated with elastic properties based on lithology, porosity, other subsurface properties, and/or relationships between subsurface properties in the corresponding section of the subsurface region. A section of the subsurface representation may be populated with elastic properties based on field data, rock-physics models, known relationships between subsurface properties, and/or other information.

In some implementations, multiple versions of a section of the subsurface representation may be generated. Multiple versions of a section may be generated for potential inclusion in the subsurface region. For example, different versions of a section of the subsurface representation may be generated and/or different sections of previously generated subsurface representations may be selected for potential inclusion in the subsurface representation. A single version of the section may be selected for inclusion in the subsurface representation. The version of the section that best matches the seismic data for the corresponding section of the subsurface region may be selected for inclusion in the subsurface representation.

The subsurface representation may be generated section by section, from a base section to a top section. The base section may refer to the lowest section of the subsurface representation. The base section may correspond to the bottom section of the subsurface region. The top section may refer to the highest section of the subsurface representation. The top section may correspond to the top section of the subsurface representation. The subsurface representation may be generated from bottom to the top.

An overlying section of the subsurface representation may be generated after validation of an underlying section. The underlying section may be validated based on the simulated seismic characteristics (e.g., simulated seismic data, simulated seismic traces) matching actual/measured seismic characteristics (e.g., seismic data, seismic traces) in the corresponding section of the subsurface region. The underlying section may provide one or more boundary conditions to constrain generation of the overlying section. For example, the boundary condition(s) provided by the underlying section to constrain the generation of the overlying section may include lower geometry of the overlying section. The shape of the upper part of the underlying section may fix the shape of the lower part of the overlying section. The shape of the lower part of the overlying section may be set when the underlying section is validated (locked in the subsurface representation). The boundary condition(s) provided by the underlying section to constrain the generation of the overlying section may include further initial conditions for sediment transport. The initial conditions to forward model the overlying section may be set when the underlying section is validated. Other boundary conditions provided by the underlying section to constrain the generation of the overlying section are contemplated.

The simulated seismic characteristic component 106 may be configured to determine simulated seismic characteristics in the section(s) of the subsurface representation. Determining simulated seismic characteristics in a section of a subsurface region may include ascertaining, approximating, calculating, establishing, estimating, finding, identifying, obtaining, quantifying, and/or otherwise determining the simulated seismic characteristics in the section of the subsurface region. Determining simulated seismic characteristics in a section of a subsurface region may include determining types and/or values of the simulated seismic characteristics in the section of the subsurface region. Determining simulated seismic characteristics in a section of the subsurface representation may include simulating seismic characteristics in the section of the subsurface representation. In some implementations, the simulated seismic characteristics may include simulated seismic traces, simulated seismic data, and/or other simulated seismic characteristics. Determining simulated seismic traces in a section of a subsurface representation may include determining location, direction, amount, and/or other characteristics of seismic traces in the section of the subsurface representation. Other types of simulated seismic characteristics are contemplated.

The simulated seismic characteristics in a section of the subsurface representation may be determined based on the simulated subsurface configuration in the section of the subsurface representation and/or other information. The simulated seismic characteristics in a section of the subsurface representation may be determined by forward modeling the simulated seismic characteristics using the simulated subsurface configuration in the section of the subsurface representation. For example, the simulated subsurface configuration (e.g., elastic properties, such as wave velocity and density of materials) in a section of the subsurface representation may be used to determine seismic reflectivity in the section of the subsurface representation, and wavelets may be placed on the seismic reflectivity to simulate seismic traces. The seismic traces in a section of the subsurface representation may be simulated using one or more techniques (e.g., simple convolution, acoustic modeling, elastic modeling). The seismic traces in a section of the subsurface representation may be simulated using one or more wavelet frequencies. Same or different wavelet frequencies may be used to simulate seismic traces in different sections of the subsurface representation.

The validation component 108 may be configured to validate the section(s) of the subsurface representation. Validating a section of the subsurface representation may include confirming, determining, establishing, and/or otherwise validating that the section of the subsurface representation is accurate. Validating a section may include determining that the section should be included within the subsurface representation. A validated section may be locked in the subsurface representation. The validated section may be used to constrain generation of the next/overlying section of the subsurface representation.

A section of the subsurface representation may be validated based on the simulated seismic characteristics in the section of the subsurface representation matching the seismic characteristics in a corresponding section of the subsurface region and/or other information. For example, a section of the subsurface representation may be validated based on simulated seismic traces/data in the section matching the actual/measured seismic traces/data in the corresponding section of the subsurface region. Simulated seismic traces and actual/measured seismic traces may be compared line-by-line or multiple lines (e.g., groups of lines, moving window of lines) at a time.

Simulated seismic characteristics in a section of the subsurface representation matching the seismic characteristics in a corresponding section of the subsurface region may include the simulated seismic characteristics being consistent with the seismic characteristics. Simulated seismic characteristics in a section of the subsurface representation matching the seismic characteristics in a corresponding section of the subsurface region may include the differences between the simulated seismic characteristics and the seismic characteristics being less than a threshold amount. Simulated seismic characteristics in a section of the subsurface representation matching the seismic characteristics in a corresponding section of the subsurface region may include the similarity (e.g., cross-correlation) between the simulated seismic characteristics and the seismic characteristics being greater than a threshold amount. For example, simulated seismic characteristics in a section of the subsurface representation matching the seismic characteristics in a corresponding section of the subsurface region may include the simulated seismic traces/data in the section of the subsurface representation being sufficiently similar (e.g., in location, direction, and/or amount) to the seismic traces/data in the corresponding section of the subsurface region. The degree of similarity between the simulated seismic characteristics and the actual/measured seismic characteristics required for validation of a section of the subsurface representation may be fixed or variable.

If a section of the subsurface representation is not valid (based on the simulated seismic characteristics in the section of the subsurface representation not matching the seismic characteristics in a corresponding section of the subsurface region), another section of the subsurface representation may be generated and compared with the seismic characteristics in the corresponding section of the subsurface region. Generation and validation of the section may be repeated until a section is validated for inclusion in the subsurface representation.

In some implementations, multiple versions of a section of a subsurface representation may be generated, and a single version of the section may be selected for inclusion in the subsurface representation based on the selected version having simulated seismic characteristics closest to the seismic characteristics in the corresponding section of the subsurface region. For example, multiple versions of a section may be sequentially generated for comparison with the seismic characteristics in the corresponding section of the subsurface region. Generation may be stopped once a version with simulated seismic characteristics matching the seismic characteristics in the corresponding section of the subsurface region is validated and locked in the subsurface representation. As another example, multiple parts of previously generated subsurface representations may be selected for potential inclusion in the subsurface representation and the part that has simulated seismic characteristics closest to the seismic characteristics in the corresponding section of the subsurface region may be validated and locked in the subsurface representation.

In some implementations, exploration, development, and/or production from the subsurface region may be performed based on the subsurface representation for the subsurface region and/or other information. The subsurface representation for the subsurface region may be used in exploration of the subsurface region, development of the subsurface region, and/or production from the subsurface region. For example, the subsurface representation for the subsurface region may be used to determine the location of equipment in the subsurface region (e.g., where to place wells, depths of wells, where to place water disposal equipment), the type of equipment in the subsurface region, the design of equipment in the subsurface region, and/or the operation parameters of equipment in the subsurface region (e.g., how to drill wells, how to inject fluid).

Production from the subsurface region may include resource recovery from the subsurface region. Resource recovery from a subsurface region may include accessing, extracting, storing, transporting, utilizing, and/or otherwise recovering resource from the subsurface region. Resource recovery from a subsurface region may be performed by using the subsurface representation for the subsurface region to assist, automate, carry out, control, design, facilitate, enable, implement, initiate, plan, schedule, set up, and/or otherwise perform the resource recovery from the subsurface region. Performing resource recovery from a subsurface region may include starting, stopping, changing, preventing, and/or otherwise controlling the resource recovery from the subsurface region.

Implementations of the disclosure may be made in hardware, firmware, software, or any suitable combination thereof. Aspects of the disclosure may be implemented as instructions stored on a machine-readable medium, which may be read and executed by one or more processors. A machine-readable medium may include any mechanism for storing or transmitting information in a form readable by a machine (e.g., a computing device). For example, a non-transitory, tangible computer-readable storage medium may include read-only memory, random access memory, magnetic disk storage media, optical storage media, flash memory devices, and others, and a machine-readable transmission media may include forms of propagated signals, such as carrier waves, infrared signals, digital signals, and others. Firmware, software, routines, or instructions may be described herein in terms of specific exemplary aspects and implementations of the disclosure, and performing certain actions.

As used herein, the phrase “configured to” is intended to be interpreted broadly, as “being capable of or suitable for performing” some function or feature, without requiring any adaptations to provide said function or feature.

In some implementations, some or all of the functionalities attributed herein to the system 10 may be provided by external resources not included in the system 10. External resources may include hosts/sources of information, computing, and/or processing and/or other providers of information, computing, and/or processing outside of the system 10.

Although the processor 11, the electronic storage 13, and the electronic display 14 are shown to be connected to the interface 12 in FIG. 1, any communication medium may be used to facilitate interaction between any components of the system 10. One or more components of the system 10 may communicate with each other through hard-wired communication, wireless communication, or both. For example, one or more components of the system 10 may communicate with each other through a network. For example, the processor 11 may wirelessly communicate with the electronic storage 13. By way of non-limiting example, wireless communication may include one or more of radio communication, Bluetooth communication, Wi-Fi communication, cellular communication, infrared communication, or other wireless communication. Other types of communications are contemplated by the present disclosure.

Although the processor 11, the electronic storage 13, and the electronic display 14 are shown in FIG. 1 as single entities, this is for illustrative purposes only. One or more of the components of the system 10 may be contained within a single device or across multiple devices. For instance, the processor 11 may comprise a plurality of processing units. These processing units may be physically located within the same device, or the processor 11 may represent processing functionality of a plurality of devices operating in coordination. The processor 11 may be separate from and/or be part of one or more components of the system 10. The processor 11 may be configured to execute one or more components by software; hardware; firmware; some combination of software, hardware, and/or firmware; and/or other mechanisms for configuring processing capabilities on the processor 11.

It should be appreciated that although computer program components are illustrated in FIG. 1 as being co-located within a single processing unit, one or more of computer program components may be located remotely from the other computer program components. While computer program components are described as performing or being configured to perform operations, computer program components may comprise instructions which may program processor 11 and/or system 10 to perform the operation.

While computer program components are described herein as being implemented via processor 11 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 11 may be configured to execute one or more additional computer program components that may perform some or all of the functionality attributed to one or more of computer program components described herein.

The electronic storage media of the electronic storage 13 may be provided integrally (i.e., substantially non-removable) with one or more components of the system 10 and/or as removable storage that is connectable to one or more components of the system 10 via, for example, a port (e.g., a USB port, a Firewire port, etc.) or a drive (e.g., a disk drive, etc.). The electronic storage 13 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 13 may be a separate component within the system 10, or the electronic storage 13 may be provided integrally with one or more other components of the system 10 (e.g., the processor 11). Although the electronic storage 13 is shown in FIG. 1 as a single entity, this is for illustrative purposes only. In some implementations, the electronic storage 13 may comprise a plurality of storage units. These storage units may be physically located within the same device, or the electronic storage 13 may represent storage functionality of a plurality of devices operating in coordination.

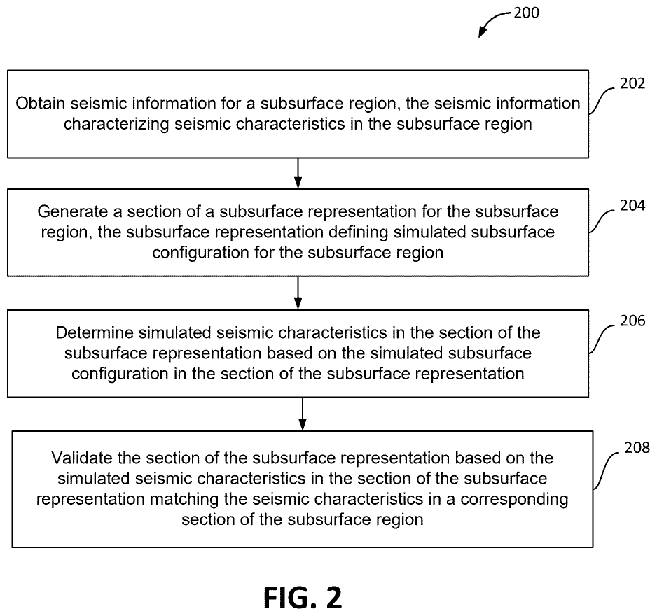

FIG. 2 illustrates a method 200 for subsurface modeling using seismic-stratigraphic validation. The operations of method 200 presented below are intended to be illustrative. In some implementations, method 200 may be accomplished with one or more additional operations not described, and/or without one or more of the operations discussed. In some implementations, two or more of the operations may occur substantially simultaneously.

In some implementations, method 200 may be implemented in one or more processing devices (e.g., a digital processor, an analog processor, a digital circuit designed to process information, a central processing unit, a graphics processing unit, a microcontroller, an analog circuit designed to process information, a state machine, and/or other mechanisms for electronically processing information). The one or more processing devices may include one or more devices executing some or all of the operations of method 200 in response to instructions stored electronically on one or more electronic storage media. The one or more processing devices may include one or more devices configured through hardware, firmware, and/or software to be specifically designed for execution of one or more of the operations of method 200.

Referring to FIG. 2 and method 200, at operation 202, seismic information for a subsurface region may be obtained. The seismic information may characterize seismic characteristics in the subsurface region. In some implementations, operation 202 may be performed by a processor component the same as or similar to the seismic characteristic component 102 (Shown in FIG. 1 and described herein).

At operation 204, a section of a subsurface representation for the subsurface region may be generated. The subsurface representation may define simulated subsurface configuration for the subsurface region. In some implementations, operation 204 may be performed by a processor component the same as or similar to the section component 104 (Shown in FIG. 1 and described herein).

At operation 206, simulated seismic characteristics in the section of the subsurface representation may be determined based on the simulated subsurface configuration in the section of the subsurface representation. In some implementations, operation 206 may be performed by a processor component the same as or similar to the simulated seismic characteristic component 106 (Shown in FIG. 1 and described herein).

At operation 208, the section of the subsurface representation may be validated based on the simulated seismic characteristics in the section of the subsurface representation matching the seismic characteristics in a corresponding section of the subsurface region and/or other information. In some implementations, operation 208 may be performed by a processor component the same as or similar to the validation component 108 (Shown in FIG. 1 and described herein).

The subsurface representation may be generated section by section, from a base section to a top section. An overlying section may be generated after validation of an underlying section. The underlying section may provide one or more boundary conditions to constrain generation of the overlying section.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A system for subsurface modeling using seismic-stratigraphic validation, the system comprising:
one or more physical processors configured by machine-readable instructions to:
obtain seismic information for a subsurface region, the seismic information characterizing seismic characteristics in the subsurface region;
generate a section of a subsurface representation for the subsurface region, the subsurface representation defining simulated subsurface configuration for the subsurface region;
determine simulated seismic characteristics in the section of the subsurface representation based on the simulated subsurface configuration in the section of the subsurface representation; and
validate the section of the subsurface representation based on the simulated seismic characteristics in the section of the subsurface representation matching the seismic characteristics in a corresponding section of the subsurface region;
wherein:
the subsurface representation is generated section by section, from a base section to a top section;
an overlying section is generated after validation of an underlying section; and
the underlying section provides a boundary condition to constrain generation of the overlying section.

2. The system of claim 1, wherein the seismic information for the subsurface region includes field measurement from the subsurface region.

3. The system of claim 1, wherein the seismic characteristics include seismic traces and the simulated seismic characteristics include simulated seismic traces.

4. The system of claim 1, wherein the boundary condition provided by the underlying section to constrain the generation of the overlying section includes lower geometry of the overlying section.

5. The system of claim 4, wherein the boundary condition provided by the underlying section to constrain the generation of the overlying section further includes initial conditions for sediment transport.

6. The system of claim 1, wherein the simulated subsurface configuration in the section of the subsurface representation includes elastic properties.

7. The system of claim 6, wherein the section of the subsurface representation is populated with the elastic properties based on materials in the corresponding section of the subsurface region.

8. The system of claim 1, wherein a given section of the subsurface representation corresponds to a layer of the subsurface region.

9. The system of claim 1, wherein:
multiple versions of the section are generated; and
a single version of the section is selected for inclusion in the subsurface representation.

10. The system of claim 1, wherein exploration, development, and/or production from the subsurface region is performed based on the subsurface representation for the subsurface region.

11. A method for subsurface modeling using seismic-stratigraphic validation, the method comprising:
obtaining seismic information for a subsurface region, the seismic information characterizing seismic characteristics in the subsurface region;
generating a section of a subsurface representation for the subsurface region, the subsurface representation defining simulated subsurface configuration for the subsurface region;
determining simulated seismic characteristics in the section of the subsurface representation based on the simulated subsurface configuration in the section of the subsurface representation; and
validating the section of the subsurface representation based on the simulated seismic characteristics in the section of the subsurface representation matching the seismic characteristics in a corresponding section of the subsurface region;
wherein:
the subsurface representation is generated section by section, from a base section to a top section;
an overlying section is generated after validation of an underlying section; and
the underlying section provides a boundary condition to constrain generation of the overlying section.

12. The method of claim 11, wherein the seismic information for the subsurface region includes field measurement from the subsurface region.

13. The method of claim 11, wherein the seismic characteristics include seismic traces and the simulated seismic characteristics include simulated seismic traces.

14. The method of claim 11, wherein the boundary condition provided by the underlying section to constrain the generation of the overlying section includes lower geometry of the overlying section.

15. The method of claim 14, wherein the boundary condition provided by the underlying section to constrain the generation of the overlying section further includes initial conditions for sediment transport.

16. The method of claim 11, wherein the simulated subsurface configuration in the section of the subsurface representation includes elastic properties.

17. The method of claim 16, wherein the section of the subsurface representation is populated with the elastic properties based on materials in the corresponding section of the subsurface region.

18. The method of claim 11, wherein a given section of the subsurface representation corresponds to a layer of the subsurface region.

19. The method of claim 11, wherein:
multiple versions of the section are generated; and
a single version of the section is selected for inclusion in the subsurface representation.

20. The method of claim 11, wherein exploration, development, and/or production from the subsurface region is performed based on the subsurface representation for the subsurface region.
